(19) United States
(12) Patent Application Publication
(10) Pub. No.: US 2008/0047375 A1
(43) Pub. Date: Feb. 28, 2008

(54) Autonomous mobile apparatus

(75) Inventor: Takafumi Sonoura, Fuchu-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/892,064

(22) Filed: Aug. 20, 2007

(30) Foreign Application Priority Data
Aug. 22, 2006 (JP) 2006-225673

(51) Int. Cl. G01C 19/04; G01C 19/16

(52) U.S. Cl. 74/5.22; 74/5.4; 74/5 R

(57) ABSTRACT

According to an aspect of the present invention, there is provided an autonomous mobile apparatus including a movable body, a control moment gyro that generates a torque, a gyro unit that pivotably supports the control moment gyro about a first axis and a gimbal that pivotably supports the gyro unit about a second axis and is pivotable to the movable body about a third axis that is different from the second axis.

### CROSS-REFERENCE TO RELATED APPLICATIONS

The entire disclosure of Japanese Patent Application No. 2006-225673 filed on Aug. 22, 2006 including specification, claims, drawings and abstract is incorporated herein by reference in its entirety.

### BACKGROUND OF THE INVENTION

1. Field of the Invention

An aspect of the present invention relates to an autonomous mobile apparatus suitably used for, for example, a posture control system of a movable body.

2. Description of the Related Art

As for the method of controlling the posture of a mobile robot autonomously, various techniques are known. The device called a control moment gyro (CMG) generates a posture-controlling torque by pivoting a high-speed rotary body around an axis different from a rotational axis of the high-speed rotary body. While the control using CMG can acquire a significantly large torque compared with a reaction wheel (RW), CMG needs complicated controls, such as avoidance of singular points and limitation of a steering law. JP-A-2004-9205 discloses a bipedal robot provided with twin-type CMGs as a technique of providing a plurality of CMGs in a movable body.

However, the bipedal robot described in JP-A-2004-9205 requires special conditions, such as juxtaposing two gimbals having the same characteristics and rotating the gimbals at the same speed in directions opposite to each other. When a gyro unit having a plurality of CMGs is loaded on a movable body, such as a robot, an external torque generated by the motion of the movable body is transmitted into the gyro unit. Therefore, design of the gyro unit, such as arrangements of gimbals, must be done with consideration of the external torque. And, complicated controlling for the gimbals must be the performed.

### SUMMARY OF THE INVENTION

According to an aspect of the present invention, there is provided an autonomous mobile apparatus including a movable body, a control moment gyro that generates a torque, a gyro unit that pivotably supports the control moment gyro about a first axis and a gimbal that pivotably supports the gyro unit about a second axis and pivotablly supports the gyro to the movable body about a third axis that is different from the second axis.

### BRIEF DESCRIPTION OF THE DRAWINGS

Embodiment may be described in detail with reference to the accompanying drawings, in which:

FIGS. 1A and 1B are views for explaining a two-wheeled carriage to which the embodiment is applied;

FIG. 2 is a view schematically showing the configuration of a gyro unit according to the embodiment;

FIG. 3 is a view for explaining gyro effects;

FIG. 4 is a view schematically showing a gimbal according to the embodiment;

FIGS. 5A and 5B are views for explaining a control system according to the embodiment;

FIG. 6 is a view showing a first exemplary configuration of the torque output path way according to the embodiment;

FIG. 7 is a view showing a second exemplary configuration of the torque output path way according to the embodiment;

FIG. 8 is a view showing a third exemplary configuration of the torque output path way according to the embodiment;

FIGS. 9A and 9B are views for explaining an example of control using a moving mechanism according to the embodiment; and

FIGS. 10A and 10B are views for explaining another example of control according to the embodiment.

### DETAILED DESCRIPTION OF THE INVENTION

Hereinafter, an embodiment according to the present invention will be described with reference to the accompanying drawings. In each of the drawings, the same elements are denoted by the same reference numerals, and duplicated description thereof is omitted.

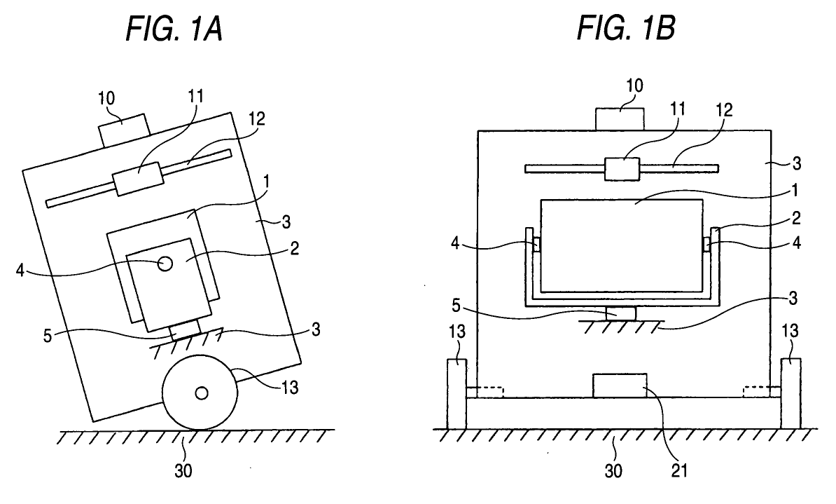

The autonomous mobile apparatus according to the embodiment is applied to a posture control system of a robot, such as a two-wheeled carriage. The robot is an independent two-wheel-drive type mobile carriage, and includes a robot body 3 as a movable body, wheels 13 in contact with a floor surface 30 where the robot moves, and a sensor 10 which measures a posture state amount related to the posture of the robot body 3, as shown in FIGS. 1A and 1B.

The wheels 13 have an axle to be driven by a motor, etc. The robot moves in the back-and-forth direction or in an oblique direction according to the constraint conditions of the wheels 13. The robot can also be moved by, such as feet, instead of the wheels 13.

The sensor 10 is functioning as a measuring unit. The posture state amount includes, for example, the position or angular velocity of a robot in the absolute coordinate system x, y and z, or the posture of the robot in a robot coordinate system. The sensor 10 has an inclination sensor, an angular velocity sensor, an angular acceleration sensor, and a rotary encoder. The inclination sensor measures the inclination angle or posture angle of the robot body 3, and a posture gyro or a rate gyro is used as the inclination sensor. The angular velocity sensor and the angular acceleration sensor are equipped in a sensor module which detects the angular velocity and angular acceleration of the robot body 3, and detect the angular velocity and the acceleration in biaxial directions of x and y. The rotary encoder measures the rotational angular velocity, etc. of the axle. The inclination sensor, the angular velocity sensor, the angular acceleration sensor, and the rotary encoder are attached to the robot body 3 so that they can measure the position, speed or acceleration of the robot body 3 in the x-axis, y-axis, and z-axis directions, respectively, and can measure the angle, angular velocity, etc. of each of the rolling, pitching, and yawing axes about the posture of the robot body 3. The robot also monitors an external force applied to the robot as the posture state amount. The force sensor or pressure sensor which detects the external force is provided in the robot body 3 as an external force sensor.

The axle of the wheels 13 is provided with a drag sensor 21. The drag sensor 21 detects a drag force from a surface (surface part), such as the floor surface 30, the ground surface, a wall surface, or a contact surface with objects other than the robot, via the wheels 13. A force/torque sensor or a load cell is used as the drag sensor 21, and the drag sensor 21 detects the drag forces that contact surfaces of the wheels 13 or the robot itself received from the floor surface 30.

The robot body 31 is provided with a CMG unit 1, a CMG unit controlling gimbal 2, a gimbal driving unit (gimbal driving device) that is not shown, a gimbal pivot shaft 4, a gimbal pivot shaft 5, a balance weight 11, and a balance weight supporting mechanism 12.

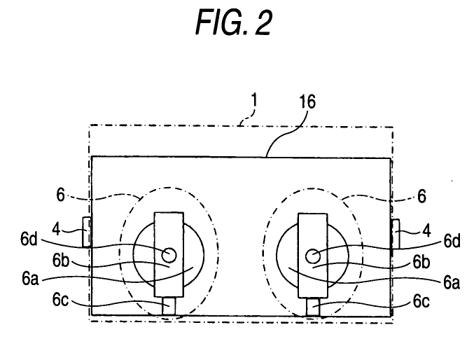

The CMG unit 1 is a gyro unit in which one or a plurality of control moment gyros that generate torques are pivotably supported. The CMG unit 1 includes, for example, a single gimbal type of two CMGs (single CMG: S-CMG) 6 inside a CMG unit outer shell 16, as a package, as shown in FIG. 2. The CMG unit 1 may house only one CMG 6. In a case where two or more CMGs 6 are pivotably supported in the CMG unit 1, internal gimbals 6b of two CMGs 6 are arranged so that pivot shafts of the internal gimbals 6b are parallel to each other. Each CMG 6 has a gyro wheel 6a that is a rotary body, and an internal gimbal 6b which rotates around a vertical (perpendicular) gimbal pivot shaft 6c which supports a gyro wheel pivot shaft 6d, and is orthogonal to the gyro wheel pivot shaft 6d.

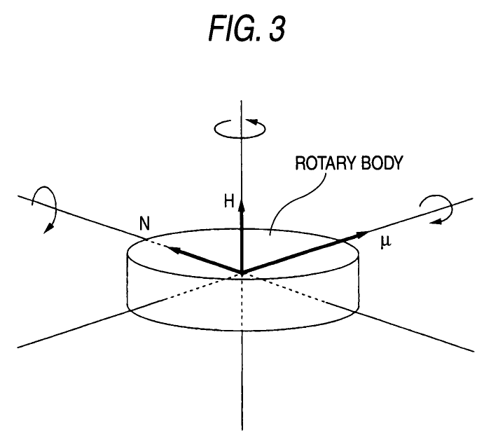

As shown in FIG. 3, if a moment μ is applied to the rotary body (like the gyro wheel 6a) in the direction of a rotational axis (μ axis) orthogonal to a rotational axis (H axis) of the rotary body itself in a state where the rotary body has rotated at high speed around the H axis, a gyro moment N will be generated in the direction of a rotational axis orthogonal to the H axis and μ axis (this is called gyro effects). This gyro moment N is expressed by Equation (1).

$$N = - μ \times H \\ ( H = I \cdot ω , {I}_{z} = \frac{1}{2} {Mr}^{2} , {I}_{x} = {I}_{y} = ( \frac{{r}^{2}}{2} + \frac{{h}^{2}}{12} ) M ) \qquad Equation ( 1 )$$

Here, “I” represents the inertia moment of a rotary body, “Iₓ”, “I_{y}”, and “I_{z}” represents individual components for the absolute coordinate system x, y, and z, “ω” represents the rotational angular velocity of the rotary body, “μ” represents the pivot angular velocity of a gimbal, “M” represents the mass of the rotary body, “r” represents the radius of a cylindrical rotary body, and “h” represents the height (thickness) of the cylindrical rotary body.

Each CMG 6 generates the gyro moment N in a non-contact state with the outside, and utilizes the generated gyro moment N as an output torque. That is, the CMG 6 is functioning as Toruca (an apparatus that generates torque).

One single gimbal type CMG 6 can generate uniaxial or biaxial torque. To perform a triaxial control, the robot according to the embodiment is loaded with a plurality of CMGs 6, and appropriately controls the torque of each CMG 6. As a number of CMG 6 loaded on a robot increases, degree of freedom redundant of the robot is increased. Therefore, a plurality of CMG 6 are loaded and controlled to avoid the singular point on the control. In addition, a double gimbal type CMG or more can be used as the CMG 6.

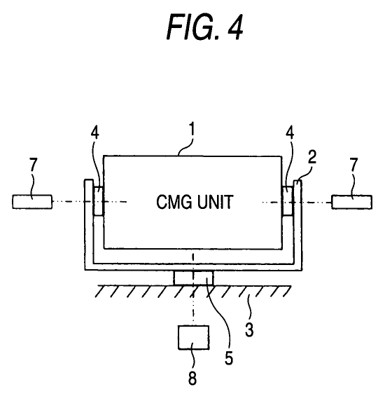

The CMG unit controlling gimbal 2 is a gimbal that includes a gimbal pivot shaft 4 that pivotably supports the CMG unit 1, and is pivotable around an axis orthogonal to the rotational axis of the gimbal pivot shaft 4 with respect to the robot body 3, as shown in FIG. 4. The gimbal pivot shaft 4 is a pivot shaft about which the CMG unit 1 and the CMG unit controlling gimbal 2 are pivoted. The gimbal pivot shaft 4 may be attached to both the CMG unit 1 and the CMG unit controlling gimbal 2 as one member, or may be formed in either the CMG unit 1 or the CMG unit controlling gimbal 2. The gimbal pivot shaft 5 is a pivot shaft around witch the CMG unit 1 and the CMG unit controlling gimbal 2 are pivoted with respect to the robot body 3. The gimbal pivot shaft 5 may be attached to both the robot body 3 and the CMG unit controlling gimbal 2 as one member, or may be formed in either the CMG unit 3 or the CMG unit controlling gimbal 2.

The gimbal driving units 7 and 8 are, for example, motors which drive the gimbal pivot shafts 4 and 5, respectively. The gimbal driving units 7 and 8 may be provided outside the CMG unit controlling gimbal 2, may be provided inside the CMG unit 1, or may be formed integrally with the gimbal pivot shafts 4 and 5.

The CMG unit 1 has one degree of freedom for each of pivot around the gimbal pivot shaft 4 and pivot around the gimbal pivot shaft 5, respectively, and axis servo control of both the gimbal pivot shafts 4 and 5 may be performed by a control system assembled into the robot.

The robot according to the embodiment controls the posture of the CMG unit 1 relative to the robot body 3 in a desired posture by using the gimbal pivot shafts 4 and 5. In other words, the CMG unit controlling gimbal 2 has the degree of freedom of one or more axes, and can generate torques in two directions. The CMG unit controlling gimbal 2, the gimbal driving units 7 and 8 that drive the CMG unit controlling gimbal 2, and a control system determine the posture of the CMG unit 1 relative to the robot body 3 in cooperation with one another.

The robot according to the embodiment may be provided with a gimbal mechanism including a set of two or more CMGs 6 so as to have redundancy. A variation in the posture state of the robot body 3 may be offset by the gimbal mechanism having the redundancy. A robot may be provided with a plurality of CMG unit controlling gimbals 2.

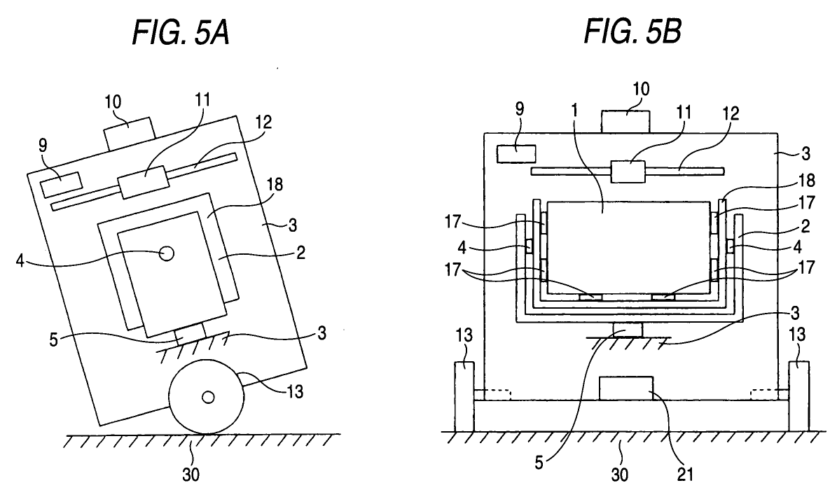

Torque sensors can be attached to the CMG unit 1 according to the embodiment. In a robot having the torque sensors, a control unit 9 is provided as shown in FIGS. 5A and 5B.

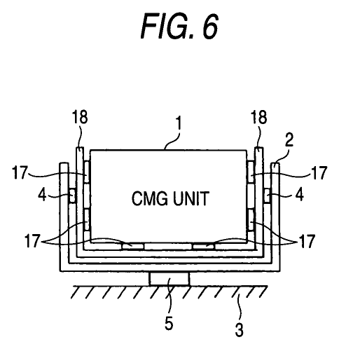

The torque sensors 17 measure the magnitude of torques around two pivot shafts pivotably supporting the CMG unit 1 in the direction of pivot of two degrees of freedom. For example, component force meter are used as the torque sensors. As shown in FIG. 6, the CMG unit 1 is stored in an external unit 18 having a substantially case-like appearance. Six component force meters are fixed between the CMG unit 1, and the side walls and bottom of the external unit 18. The CMG unit 1 and the external unit 18 are physically coupled with each other. The external unit 18 is functioning as a case that is provided between the CMG unit controlling gimbal 2 and the CMG unit 1, and is pivotably supported by the CMG unit controlling gimbal 2. The side surfaces of the external unit 18 are pivotably supported by the CMG unit controlling gimbal 2. The external unit 18 is adapted to be pivotable around the gimbal pivot shaft 4 which is interposed between the CMG unit controlling gimbal 2 and the external unit 18. Thereby, the CMG unit 1 is pivotable around the gimbal pivot shaft 4 in conjunction with the external unit 18.

Four component force meters fixed between the CMG unit 1 and the side walls of the external unit 18 detect the torques around the gimbal pivot shaft 4, respectively, and two component force meters w fixed between the CMG unit 1 and the bottom of the external unit 18 detect the torques around the gimbal pivot shaft 5, respectively. The torque sensors 17 are attached onto output pathways of the torques output to the outside from the CMG unit 1 to detect the torques of each axis component in each attached portion. When a plurality of CMGs 6 are used to generate control torques, the CMG unit 1 is configured so as to confine the CMGs 6 to a constant area and have one or more transmission pathways, along which the control torques are transmitted to the robot body 3 while being monitored by the torque sensors 17.

The torques output by the CMGs 6 are measured, for example, by observing the torques in specific points or specific spots, respectively, like six attachment spots. Along the force transmission structure of the robot, torques of one or more directions which is generated by one or more CMGs 6 housed in the CMG unit 1 are transmitted and measured. The transmitted torques are monitored, whereby the torque sensors 17 exclusively (collectively) detect the torques output to the robot body 3 from the packaged CMG unit 1.

The control unit 9 adds up the torques around the gimbal pivot shafts 4 and 5 measured by the torque sensors 17 to estimate the torque generated by the whole CMG unit 1. A feedback loop for torque control to a target torque is formed using the added value. The feedback control using the torque sensors 17 realizes highly precise control compared with the technique of controlling the inside of a feedback loop of the posture angle or angular velocity level of the robot body 3 by an open loop.

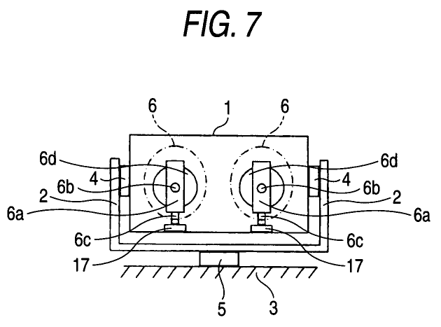

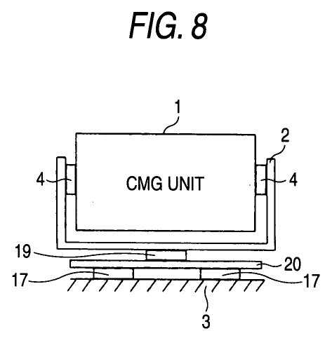

As for the force transmission structure according to the embodiment, the torque sensors 17 may be attached between one or more internal gimbals 6b and the bottom of the CMG unit 1 to detect the torque around the gimbal pivot shaft 6c of each internal gimbal 6b, as shown in FIG. 7. As for the force transmission structure according to the embodiment, a gimbal pivot shaft 19 pivotably supports the CMG unit controlling gimbal 2, and a supporting member 20, such as a substantially flat plate, may be provided, and the torque sensors 17 may be fixed between the supporting member 20 and the robot body 3 to detect the torque around the gimbal pivot shaft 19, as shown in FIG. 8. Even if such a force transmission structure is used, highly efficient feedback control can be performed.

The control unit 9 (FIGS. 5A and 5B) controls the operation of the robot body 3, and controls the pivot of the CMG unit controlling gimbal 2 based on a posture state amount, a posture target value and a posture variation. The control unit 9 controls the operation of the CMGs 6 individually. The robot according to the embodiment can be provided with a torque distribution unit or torque filter which distributes an output torque, and the control unit 9 controls the torque distribution unit according to a band or a maximum output limit, thereby distributing or decomposing the output torque. The control unit 9 is able to not only calculate a target value of posture control internally, but also acquire it from the outside. The control unit 9 is realized by a CPU (central processing unit), ROM, RAM, IC, LSI, etc. The control unit 9 can be provided in any one of the inside or outside of the robot body 3.

The balance weight 11 is a weight by which the center of gravity of the robot body 3 is adjusted. The balance weight supporting mechanism 12 supports the balance weight 11 so as to be movable to back and forth, right and left, and up and down, and may be fixed to the inside or outside of the robot body 3. Both of the balance weight 11 and the balance weight supporting mechanism 12 are functioning as a gravity center adjusting mechanism. When the balance weight 11 is moved inside the robot body 3 by the balance weight supporting mechanism 12, the center of gravity of the robot is changed and adjusted to a desired position.

The control unit 9 can control the posture of the robot body 3 with a combination of torque generation of the CMG unit 1 and adjustment of the center of gravity of the balance weight 11. The control unit 9 monitors a disturbance sensor attached to the robot, and controls the balance weight so that, when the disturbance sensor detects a disturbance, such as an impact, the balance weight 11 may be moved to generate a reaction force against the disturbance. The control unit 9 utilizes the torque generation using the CMG unit 1 in combination with the control using the balance weight 11. Thereby, even in a case where an external force having a magnitude that cannot be canceled by the CMG unit 1 solely is applied to the robot, the control unit is able to control the robot body 3 appropriately.

On the basis of the above-described configuration, the autonomous posture control operation of the robot according to the embodiment of the invention will be described.

The torque sensors 17 monitor the torques transmitted to the outside of the CMG unit 1.

The control unit 9 measures the posture variation of the robot body 3 using the sensor 10. In a case where one or a plurality of torque sensors 17, such as, two, or six sensors, are used, the control unit 9 controls the CMG unit 1 using a sum of individual axis components which are measured by the torque sensors 17. The control unit 9 performs feedback control of the CMG unit controlling gimbal 2 so that a posture variation may be cancelled using the torque of each axis which is measured by each torque sensor 17.

The control unit 9 controls to suppress transmission of the motion of the robot body 3 in a real space to the CMG unit 1 loaded inside the robot. When the robot, for example, makes a turn of 90° around the perpendicular z-axis, the CMG unit controlling gimbal 2 operates to make a turn of 90° around the z-axis. Accordingly, control to keep the posture of the CMG unit 1 in the absolute coordinate system x, y, and z is made. Since this makes it hard to transmit the operation of the robot to the CMGs 6 inside the CMG unit 1, generation of an unnecessary gyro moment N caused by the operation of the robot can be suppressed more effectively.

The sensor 10 detects posture state amounts, such as the posture angle and rotational angular velocity of a robot. The control unit 9 calculates a deviation (or a predetermined variation in the posture state amount) between a detected or measured posture state amount and a preset posture state amount, and changes the posture state amount in a direction in which the deviation becomes small, to thereby operate the CMG unit controlling gimbal 2 to generate the torque moment N. As described above, a torque for autonomous posture control is generated in a case where a plurality of CMGs 6 are used.

The robot calculates a predetermined posture variation of the robot based on posture control target values of the robot calculated therein, and multiplies the predetermined posture variation by a proper gain or a proper weighting factor, thereby performing feed forward control of the CMG unit controlling gimbal 2. This more precisely prevents generation of an unnecessary gyro moment N caused by a robot motion.

When the robot uses a single gimbal type CMG 6, the robot may be put into a state where it can not perform posture control. This is because each CMG 6 includes several singular points in its structure, and therefore a singular point state where the CMG unit 1 can not output a resultant torque due to gimbal lock is caused. The robot according to the embodiment performs control using a gimbal mechanism which is configured such that two or more CMGs 6 or a set of two or more CMGs 6 of the CMG unit 1 have redundancy in order to avoid singularity. The control unit 9 determines a pivot amount of a gimbal for outputting a required torque, using a gimbal mechanism with redundancy by a technique of utilizing a homogeneous solution which appears in a general solution of a linear equation, etc. The control unit 9 simultaneously executes gyroscope control for generating a torque required for posture control while causing the gimbal mechanism with redundancy to operate to offset the posture state variation of the robot body 3. This makes it possible for the robot loaded with single gimbal type CMGs 6 to output a torque in an intended direction even in a singular point state.

Each of CMG 6 can be configured so as to perform the simultaneous operation with the aforementioned CMG unit controlling gimbal 2, by giving the degree of freedom in redundancy to the internal gimbal 6b of a CMG 6. This make the robot possible to be loaded with single gimbal type CMG 6 to avoid singularity, similarly to the aforementioned effects. In this case, the gimbal of each CMG 6 performs not only the operation for generating the gyro moment N but also the operation for offsetting the operation of the robot.

As another control technique, when the control unit 9 directly controls the internal gimbal 6b, the control unit 9 controls to turn off (servo free state) a servo for one or two pivot axes of the CMG unit controlling gimbal 2 so as not to transmit the torque around one or two axes that is turned off to the outside. The control unit 9 controls to turn off, for example, a servo of the external CMG unit controlling gimbal 2 in the N-axis direction, and causes the internal gimbal 6b inside the CMG unit 1 to generate the torque around the turned-off axis (for example, the N-axis) under this situation. The control unit 9 causes the posture of the robot body 3 to shift to a posture convenient to be controlled in a state where torque has been generated in the internal gimbal 6b. That is, the control unit 9 guides an internal gimbal 6b for gyro posture control provided in the CMG unit 1 to be an initial position or a preset position. In this case, the control unit 9 can shift the posture of the robot body 3 to a desired posture in a state which a torque generated by each CMG 6 inside the CMG unit 1 has been cancelled using a moment generated by gravity.

In this way, the autonomous mobile apparatus changes the position of either or both of the CMG unit controlling gimbal 2 and the internal gimbal 6b to a desired position, so that a singular point can be avoided, and a correction to a state where the output torque of each CMG 6 becomes still larger can be made.

In a case where a robot controls a posture using the drag force from a floor surface, the robot utilizes a control system using the drag force measured by the drag sensor 21 attached to a surface where the wheels 13 or the robot itself contact. For example, in a case where an independent two-wheel-drive-type robot is controlled, the control unit 9 causes the wheels 13 to absorb a moment having a certain amount of magnitude related to the rotation in a rolling-axis direction (here, the front direction of the robot) in a robot coordinate system. If the value detected by the drag sensor 21 is below a moment having such a magnitude that the robot is overturned in the rolling direction (or such a magnitude that the wheels 13 float), the control unit 9 permits generation of a moment in the rolling direction, and adjusts the position of the internal gimbal 6b of the CMG unit 1 in a state where a torque in the rolling direction is output. In a case where a robot has a caster, the control unit 9 permits output of a torque having a certain amount of magnitude even in the direction of the pitching axis in addition to the rolling axis, and adjusts the position of the internal gimbal 6b of the CMG unit 1.

In a case where each force/torque sensor or load cell of the two wheels 13 detect the drag force received from a floor surface, the control unit 9 controls the robot body 3 within a range where the drag force from the floor surface 30 is not set to 0. In a case where the drag force or load cell from the force/torque sensor of each wheel 13 detects that the drag force of one of the two wheels 13 becomes small and the drag force of another wheel becomes large, the control unit 9 determines that the posture has inclined, and controls the robot body 3 so that its posture may become horizontal.

In this way, the control unit 9 controls the gyro posture inside the CMG unit 1 so that the drag force may become larger than 0. As described above, the control unit 9 can control posture shift based on the structural characteristics of a robot.

In a case where the robot is a humanoid robot, such as a bipedal robot and a multi-legged robot, or in a case where a robot can determine a contact surface position arbitrarily, the legs of the robot are arranged so as to cancel a moment generated by the CMG unit 1. In a state where the legs of the robot are arranged in this way, the control unit 9 controls the robot body 3 based on the value of a drag force detected by a force/torque sensor provided at the back of each of the legs of the robot. The control unit 9 guides the internal gimbal 6b for gyro posture control to an initial posture or a designated posture. In the robot according to the embodiment, the legs of the robot itself are arranged to be convenient to change the position of the internal gimbal 6b, so that the control unit 9 can appropriately change and adjust the position of the internal gimbal 6b even in a case where the robot is a biped robot or a multi-legged robot.

In a case where the drag sensor 21 is used, the control unit 9 guides the internal gimbal 6b until the internal gimbal 6b for gyro posture control provided inside the CMG unit 1 takes an initial position or a preset position in a state where the value of a resultant moment finally applied to the robot becomes under an critical value for overturning of the robot.

In a case where the posture angle or rotational angular velocity of a robot itself is measured by an inclination sensor or a rate gyro sensor, the control unit 9 calculates a variation in the posture state amount of the robot using posture state amounts, such as the posture angle, rotational angular velocity, and rotational angular acceleration of the robot that are detected. The control unit 9 operates the robot so that this variation may be offset by the CMG unit controlling gimbal 2.

The control unit 9 calculates a deviation between a measured state amount and a target value specified therein, multiplies the deviation by a proper gain, and operates the robot so that the multiplied value may be offset by the CMG unit controlling gimbal 2. That is, the control unit 9 also performs feedback control to determine the target value of an output torque of the CMG unit 1. The control unit 9 distributes a target torque to the operation of each CMG 6 based on a steering law of the internal gimbal 6b for gyroscope control and the position of the CMG unit controlling gimbal 2.

In a case where the robot detects an external force applied to the robot using a force sensor or pressure sensor, the force sensor or pressure sensor detects the external force applied to the robot. The control unit 9 calculates an overturning moment to be generated by the external force from the positional relationship between the detected external force and the center of rotation of the robot itself stored as a detected position and known information. The control unit 9 generates the output torque or gyro moment N of the CMG unit 1 in a direction in which the calculated overturning moment is offset. This can suppress overturn of the robot even when the robot receives an impact force from the outside.

As described above, even when the control of causing each CMG 6 to perform the same operation is required, the robot can perform the control of collectively operating the CMG unit 1, and the control is simplified.

According to the embodiment, a gimbal driving structure which can control a relative posture of the CMG unit 1 to the robot body 3 is provided, so that intentional operation of the robot can be absorbed by the gimbal driving structure, and each CMG 6 can be controlled correctly so as to suppress transmission of the motion of the robot into the CMG unit 1. This can autonomously stabilize the posture of the robot body 3 as a movable body.

By such comparatively simple control, even at the time of high-acceleration movement, an overturning moment generated in a movable body due to an inertial force, a reaction force, or an unexpected external force can be reduced, and overturning can be prevented while stabilizing the posture of the movable body.

(a) Control Technique Using Balance Weight 11

The control unit 9 may control the posture of the robot by controlling the position of the balance weight 11 or driving the wheels 13 to control the position of the robot itself. In this case, the robot independently generates an output torque required by the CMG unit 1, using a control system which performs control of the balance weight 11 or wheels 13. The robot performs not only the posture control by the balance weight 11 or wheels 13 but also performs an autonomous posture control in cooperation with other posture control mechanism. At this time, the robot distributes a required output torque to the CMGs 6 and balance weight 11, respectively, thereby performing posture control, in a state where the maximum output of each posture control mechanism is taken into consideration.

The control unit 9 or a torque distribution unit performs filtering of separating a low speed motion and a high-speed motion on the basis of a frequency band according to the response characteristics of each posture control mechanism, and distributes a torque based on the frequency band. The control unit 9 controls each posture control mechanism to determine an output target torque based on the filtering. For example, the control unit 9 generates a high-speed torque component by the CMGs 6, and generates a low-speed torque component by the balance weight 11.

In the robot, the posture of the robot can also be controlled using posture control mechanism other than the CMGs 6, such as a posture-changeable driving shaft including a waist joint, if necessary, together with the balance weight 11 (or instead of the balance weight 11) as a gravity center adjusting mechanism. In this case, a filter resolves a torque required for posture control calculated by the control unit 9 according to a band or a maximum output limit. The control unit 9 distributes a torque to the CMG unit 1 and other posture control mechanism, respectively, and controls a posture in cooperation with them.

In this way, the posture of the robot body 3 can be controlled by a combination of the CMG unit 1 and a gravity center adjusting mechanism, such as the balance weight 11.

(b) Control Technique Using Moving Mechanism

In the robot, movement of the center of gravity by a moving mechanism, such as wheels 13 or legs, which can be accelerated or decelerated, and generation of a torque by the CMG unit 1 can also be used together.

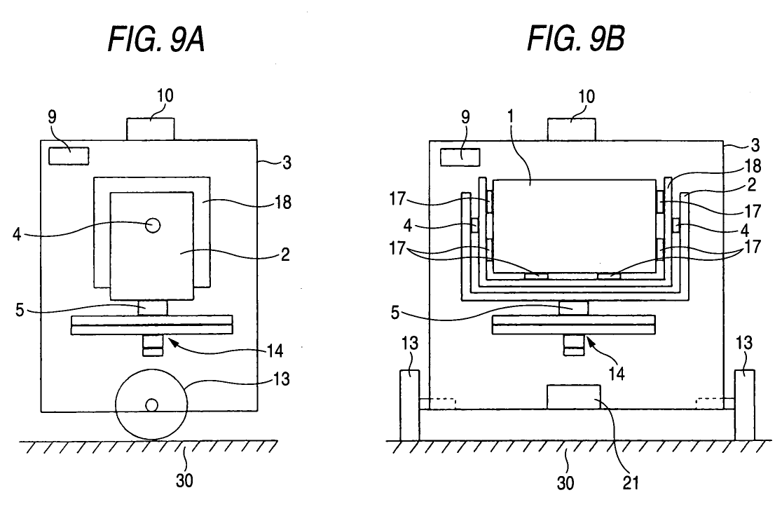

A sliding mechanism 14, as shown in FIGS. 9A and 9B, is a moving mechanism which moves the CMG unit controlling gimbal 2 with respect to the robot body 3. A translation mechanism composed of a base member attached to the inside or outside of the robot body 3 and a sliding body which slides along the base member can be used as the moving mechanism. The control unit 9 causes the CMG unit controlling gimbal 2 as a sliding body to slide in two directions including a back-and-forth direction and a right-and-left direction. The robot uses, as an example of the translation mechanism, a linear guide mechanism which constrains the sliding operation in a direction different from the sliding direction of the CMG unit controlling gimbal 2. With the sliding mechanism 14, the CMG unit 1 slides back and forth and to the right and left with respect to the robot body 3 along with the CMG unit controlling unit 2. The center of gravity of the robot is controlled by the sliding operation of the packaged CMG unit 1. This transmits a torque generated by the CMG unit 1 to the external robot body 3.

Since a rotary body itself inside each CMG 6 has comparatively large weight while the CMG 6 is provided to generate a large torque, the CMG unit 1 has considerable weight. Accordingly, the robot effectively performs gravity center control by utilizing this weight. The robot autonomously controls a posture by using of the characteristics that the change of a translation component does not affect the operation of each CMG 6. Any arbitrary sliding mechanisms may be used as the sliding mechanism 14 so long as sliding mechanisms provides the CMG unit controlling gimbal 2 two degrees of freedom (x and y directions) with respect to a horizontal plane in a posture where the robot body 3 stands upright.

The robot may use a moving mechanism what moves the CMG unit controlling gimbal 2 in the z-direction perpendicular to the horizontal plane. The robot can also use a moving mechanism which moves the CMG unit controlling gimbal 2 along the x, y, and z directions, respectively, or which moves the CMG unit controlling gimbal 2 at an angle with respect to the x, y, and z directions, respectively.

If the CMG unit 1 translates relative to the robot body 3 using the moving mechanism in this way, the posture of the robot can be stabilized using movement of the center of gravity according to a positional change of the CMG unit 1. Accordingly, the CMG unit 1 itself can be moved to autonomously control the posture of the robot body 3.

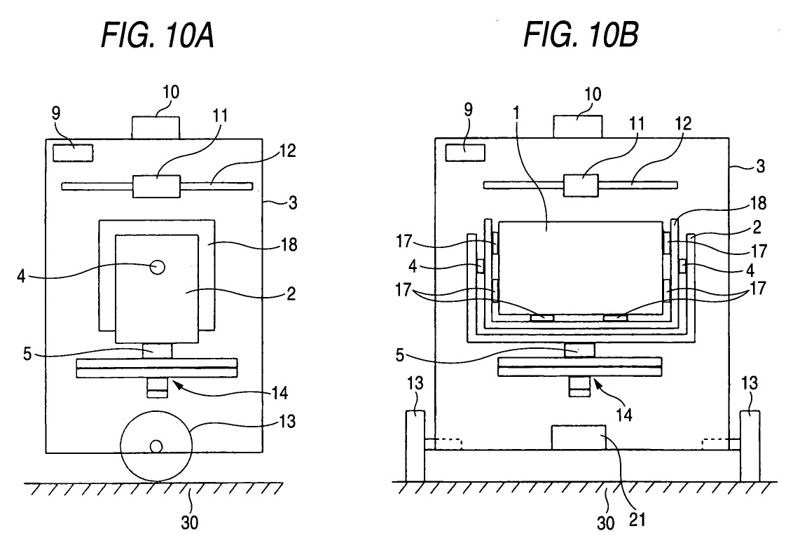

As described above, the posture of the robot body 3 may be controlled autonomously with a combination of the CMG unit 1, a moving mechanism, such as the sliding mechanism 14, and a gravity center adjusting mechanism, such as the balance weight 11, as shown in FIGS. 10A and 10B.

In this way, the posture of the robot can be stabilized by reducing an overturning moment to prevent overturning.

Also, intentional operation of a movable body such as a robot, is absorbed, and each CMG 6 is correctly controlled so that the motion of the robot may not be transmitted into the CMG unit 1. Thus, the posture of the movable body can be stabilized.

(c) Modifications

The invention is not completely limited to the above embodiment, but it can be embodied in its practical phase by modifying constituent elements without departing the scope of the invention. For example, although the robot is an inverted pendulum type robot in which a caster is not provided back and forth, the caster may be attached to the robot back and forth.

In the above description, the robot receives a drag force from the floor surface 30, etc. However, the invention can be used in a situation where gravity is not applied to a robot or in a situation where the influence of gravity is small. The invention can be used even in a case where a robot is put in a medium, such as water, or in a case where a robot moves on a water surface. In these cases, the same control as the above-mentioned control can be performed by providing a sensor which measures a force received from water, etc., or a sensor which measures the position, speed, and posture of a robot in a medium, such as water.

In addition to the packaged form, the CMG unit 1 can be configured by a plate-like or planar member on which each CMG 6 are pivotably supported within a defined region and a bearing portion that pivotably support the plate-like or planar member.

Various inventions can be made by an appropriate combination of a plurality of constituent elements disclosed in the above embodiment. For example, some constituent elements may be eliminated from all the constituent elements shown in the above embodiment. Moreover, constituent elements in different embodiments may be combined appropriately.

(d) Others

In addition, as robots are highly developed, application of the robots is diversified. Along with this, advanced posture control is increasingly required. As a robot which physically supports human beings, for example, service robots, such as a guard robot and a cargo transportation robot, are known. In order not to give an unpleasant feeling to a human being who is a user, a robot requires mobility equal to the user or superior to the user according to its service application. A robot is required to move with acceleration and deceleration of considerable magnitude, and also requires a certain large size, with a height required to perform physical operation. The invention canal so be applied in such situations. The invention is effective even in a case where the posture of a robot becomes unstable at the time of such movement. Moreover, according to the embodiment, even in a case where a robot operates at a distance close to a user, stable posture control becomes possible, and occurrence of a movement which is unfavorable to human beings can be prevented.

As a method of autonomously controlling the posture of a mobile robot, for example, an inverted pendulum type robot, there are a technique of tilting the posture angle of the robot itself in advance to suppress overturning at the time of acceleration and deceleration, a zero moment point (ZMP) method of stabilizing the posture of the robot so that the center of gravity of the robot falls within a stable region of a sole, a technique of changing the dynamic characteristics of the robot itself depending on the movement of a leg position to avoid overturning, and a technique of utilizing a reaction force generated on a rotational axis of a high-speed rotary body like a reaction wheel as a posture control torque. Meanwhile, the control of suppressing overturning requires preliminary operation which tilts a posture in advance before acceleration and deceleration is made. The control using ZMP is unstable in an unexpected external force, and the control of velocity or acceleration at the time of posture return is difficult. According to the embodiment, a very large torque can be obtained compared with a reaction wheel.

As described above, according to an aspect of the invention, there is provided an autonomous mobile apparatus capable of suppressing an external torque generated by the motion of a movable body transmitted into gimbals by simple control and controlling a control moment gyro, thereby stabilizing the posture of the movable body.

What is claimed is:

1. An autonomous mobile apparatus comprising:
a movable body;
a control moment gyro that generates a torque;
a gyro unit that pivotably supports the control moment gyro about a first axis; and
a gimbal that pivotably supports the gyro unit about a second axis and pivotablly supports the gyro to the movable body about a third axis that is different from the second axis.

2. The autonomous mobile apparatus according to claim 1 further comprising an adjusting unit that adjusts a location of the gimbal with respect to the movable body.

3. The autonomous mobile apparatus according to claim 1, wherein the control moment gyro comprises:
a rotary body that rotates around a rotation axis; and
an internal gimbal that pivotably supports the rotary body about a gimbal axis that is different from the rotation axis.

4. The autonomous mobile apparatus according to claim 3,
wherein the gyro unit is provided with at least two of the control moment gyro, and
wherein the control moment gyros are arranged so that the gimbal axes of the control moment gyros are parallel with one another.

5. The autonomous mobile apparatus according to claim 1 further comprising a torque sensor that is attached onto an output pathway of the torque, along which the torque is output from the gyro unit.

6. The autonomous mobile apparatus according to claim 1 further comprising a case that is arranged between the gyro unit and the gimbal,
wherein the case houses the gyro unit therein, and
wherein the gimbal pivotably supports the gyro unit via the case.

7. The autonomous mobile apparatus according to claim 6 further comprising a torque sensor that is attached between the case and the gyro unit.

8. The autonomous mobile apparatus according to claim 3 further comprising a torque sensor that is attached between the internal gimbal and the gyro unit.

9. The autonomous mobile apparatus according to claim 1 further comprising:
a supporting member that is arranged between the gimbal and the movable body; and
a torque sensor that is attached between the supporting member and the movable body,
wherein the gimbal is pivotably mounted on the movable body via the supporting member.

10. The autonomous mobile apparatus according to claim 1 further comprising:
a gravity center adjusting mechanism that adjusts a gravity center of the movable body; and
a control unit that controls the gimbal and the gravity center adjusting mechanism,
wherein the control unit distributes controlled variable to controlled variable of the gimbal and controlled variable of the gravity center adjusting mechanism.

11. The autonomous mobile apparatus according to claim 1 further comprising:
a wheel that is attached on the movable body and contacts with a floor surface; and
a drag sensor that detects a drag force from the floor surface via the wheel.
